(19) United States
(12) Patent Application Publication
(10) Pub. No.: US 2010/0059427 A1
(43) Pub. Date: Mar. 11, 2010

(54) Filtering System, in Particular for Filtering Liquids in Internal Combustion Engines

(75) Inventors: Thomas Petschl, Frondenberg (DE); Luiz Carlos Fritz, Sao Paulo (BR)

Correspondence Address: Mr. Gerhard Voth, Dept. VR-P;MANN+HUMMEL GMBH, Hindenburgstr. 45, Ludwigsburg, 71638, DE

(73) Assignee: MANN+HUMMEL GmbH, Ludwigsburg (DE)

(21) Appl. No.: 12/545,841

(22) Filed: Aug. 23, 2009

(30) Foreign Application Priority Data
May 13, 2005 (DE) 20 2005 007 870.0

(51) Int. Cl. B01D 35/147

(52) U.S. Cl. 210/133

(57) ABSTRACT

A filtering system has a filter housing and a filter element and having a raw side and a clean side arranged in the filter housing. Liquid introduced into the filter housing flows through the filter element from the raw side to the clean side. An overflow valve is disposed between the raw side and the clean side of the filter element. The overflow valve is moved into an open position should a pressure of the liquid on the raw side of the filter element surpass a limit value. The overflow valve has an adjustable valve body loaded by a valve spring and made from plastic material. The filter element and of the filter housing structurally supplement one another such that the filter element is positioned precisely in the filter housing and relative rotation of the filter element relative to the filter housing is prevented.

### CROSS REFERENCE TO RELATED APPLICATIONS

This application is a continuing application of pending application Ser. No. 11/914,316 having a completion date under 35 USC 371 of 11/13/2007 as a national stage application of international application Ser. No. PCT/EP2006/062274 having an international filing date of May 12, 2006, the contents of which are incorporated herein by reference in its entirety, which international application claims the benefit under 35 USC 119 of the filing date of foreign application DE 20 2005 007 870.0 filed in Germany on May 13, 2005.

### BACKGROUND OF THE INVENTION

The invention relates to a filtering system, in particular for filtering liquids in internal combustion engines, wherein the filtering system comprises a filter element insertable into a filter housing through which the liquid introduced into the filter housing flows; an overflow valve between the raw side (unfiltered side) and the clean side (filtered side) of the filter element that is moved into an open position should the pressure of the liquid on the raw side of the filter element surpass a limit value, wherein the overflow valve comprises an adjustable valve body loaded by a valve spring.

Such a filtering system is disclosed in DE 102 48 907 A1. This publication discloses a filtering system for filtering liquids in internal combustion engines that is comprised of a filter housing into which a cylindrical hollow filter element is inserted through which liquid passes radially from the exterior to the interior. Between the exterior side of the filter element and the inner wall of the filter housing there is an annular chamber that represents the raw side of the filter element. The liquid to be filtered is introduced into this annular chamber and flows subsequently radially through the filter element. The filtered liquid is removed in the axial direction from the filtering system from the interior of the filter element forming the clean side.

In order to ensure that an impermissibly high pressure increase on the raw side, for example, as a result of the filter element being soiled, does not cause destruction of components of the filtering system, an overflow valve is arranged between the raw side and the clean side of the filter element; under regular conditions it is closed and opens when a pressure increase occurs at the raw side. Through the open overflow valve unfiltered liquid flows directly from the raw side to the clean side so that the pressure decreases. After the pressure has dropped, the overflow valve automatically doses so that the raw side and the clean side are separated again.

The overflow valve is received in an end plate that delimits axially the filter element and comprises a valve body that projects into the interior of the filter element and is loaded by a valve spring into the closed position. Valve body and valve spring are comprised, for example, of metal while the end plate is made of plastic material.

Based on this prior art, the invention has the object of providing a filtering system, in particular, for filtering liquids in an internal combustion engine, in which, on the one hand, with simple measures an impermissibly high pressure increase at the raw side of the filter element is prevented and, on the other hand, an excellent recyclability is provided.

### SUMMARY OF THE INVENTION

This problem is solved in accordance with the present invention in that a filter housing is provided and a filter element having a raw side and a clean side is arranged in the filter housing, wherein a liquid introduced into the filter housing flows through filter element from the raw side to the clean side; an overflow valve is disposed between the raw side and the dean side of the filter element; wherein the overflow valve is moved into an open position should a pressure of the liquid on the raw side of the filter element surpass a limit value; wherein the overflow valve comprises an adjustable valve body loaded by a valve spring; wherein the valve body is made from plastic material; wherein the filter element and the filter housing supplement one another structurally such that the filter element is positioned exactly in the filter housing and relative rotation of the filter element relative to the filter housing is prevented. The dependant claims provide expedient embodiments.

The filtering system according to the invention has in the filter housing an overflow valve with a valve body and a valve spring wherein the valve body and expediently also the valve spring are made from plastic material. This overflow valve is comprised exclusively of plastic components that can be completely burned in a waste incinerator. This facilitates the disposal of the filtering system significantly because a cumbersome and time-consuming demounting of the filtering system and, in particular, of the overflow valve is no longer required. In the case that also the filter housing including the housing lid are made of plastic material, the entire filtering device can be burned after use.

Optionally, it is also possible to employ a valve spring made from metal.

Such an overflow valve can be arranged at different positions in the filtering system. For example, an arrangement near the bottom area of the filter element is possible adjacent to the bottom of the filter housing. For example, the overflow valve can project into a fastening socket that is expediently a unitary part of the end plate that delimits the filter element at its end face. This end plate is preferably arranged on the bottom side of the filter element that faces the housing bottom. Possible is also an arrangement in the upper area of the filter element adjacent to the housing lid or in a center tube or support tube of the filter element.

### BRIEF DESCRIPTION OF THE DRAWINGS

Further advantages and expedient embodiments can be taken from the further claims, the description, and the drawings. It is shown in:

FIG. 1 a section of a filtering system for filtering liquids in an internal combustion engine, comprising a cup-shaped filter housing, a cylindrical hollow filter element inserted into the filter housing, and a two-part lid comprising two individual disks that are connected to one another by a flow socket;

FIG. 2 the filtering system in a perspective view partially in section;

FIG. 3 the lid in a perspective view partially in section;

FIG. 4 a detail of the area of the inner thread of the flow socket, showing an elliptical geometry of the thread;

FIG. 5 a filtering system according to a further embodiment, illustrated partially in section;

FIG. 6 a view from above onto the filtering device according to FIG. 5;

FIG. 7 a view of the detail VII of FIG. 5;

FIG. 8 an overflow valve embodied as a beak valve in a perspective view;

FIG. 9 the beak valve in a view from below;

FIG. 10 a perspective view of a support member for a cylindrical hollow filter element that has one end secured on a bottom end plate wherein on the end plate a receiving or fastening socket is formed about which a sealing hose acting as an overflow valve is arranged;

FIG. 11 the bottom end plate alone in a perspective illustration;

FIG. 12 the support member including the bottom end plate shown in section;

FIG. 13a a perspective view of the support member and the bottom end plate partially in section, showing an overflow valve of an alternative configuration;

FIG. 13b a view of a similar object as shown in FIG. 13a but with an overflow valve of a different embodiment;

FIGS. 14a, b an overflow or bypass valve that is used between raw side and clean side of the filter element and has as a valve body an elastomer block that can be elastically compressed, illustrated in the closed position (FIG. 14a) and in the open position (FIG. 14b);

FIGS. 15a, b an overflow or bypass valve with an elastomer bellows as a valve body;

FIG. 16a, b an overflow or bypass valve with a foam block as a valve body;

FIG. 17 a perspective view of a filtering system with a cylindrical filter housing and an annular filter element inserted therein to which, through a check valve, liquid to be filter can be supplied;

FIG. 18 a longitudinal section of the filtering system according to FIG. 17 including connecting rings inserted into the end faces;

FIG. 19 the connecting rings shown alone;

FIG. 20 an enlarged illustration of the filtering system of FIG. 17 with a check valve embodied as a hose valve shown in closed position;

FIG. 21 an illustration corresponding to FIG. 20 but with the hose valve in open position;

FIG. 22 a perspective view of a further filtering system comprising a lid with radially extending spokes;

FIG. 23 a perspective view of yet another filtering system that comprises an overflow valve between the raw side and the clean side and is provided with axially projecting support legs;

FIG. 24 the overflow valve of FIG. 23 shown alone;

FIG. 25 a support ring for attachment to the axial end face on the overflow valve;

FIG. 26 an overflow valve in the cup-shaped filter housing with a spike arranged at the bottom of the housing which spike projects into a recess delimited by the valve housing in the overflow valve;

FIG. 27 the filter element in a plan view;

FIG. 28 the filter element according to FIG. 27 in a side view;

FIG. 29 a detail of the filter housing in a perspective illustration; and

FIG. 30 the filter element in the mounted state in the filter housing.

### DESCRIPTION OF PREFERRED EMBODIMENTS

In the Figures identical parts are identified with the same reference numerals.

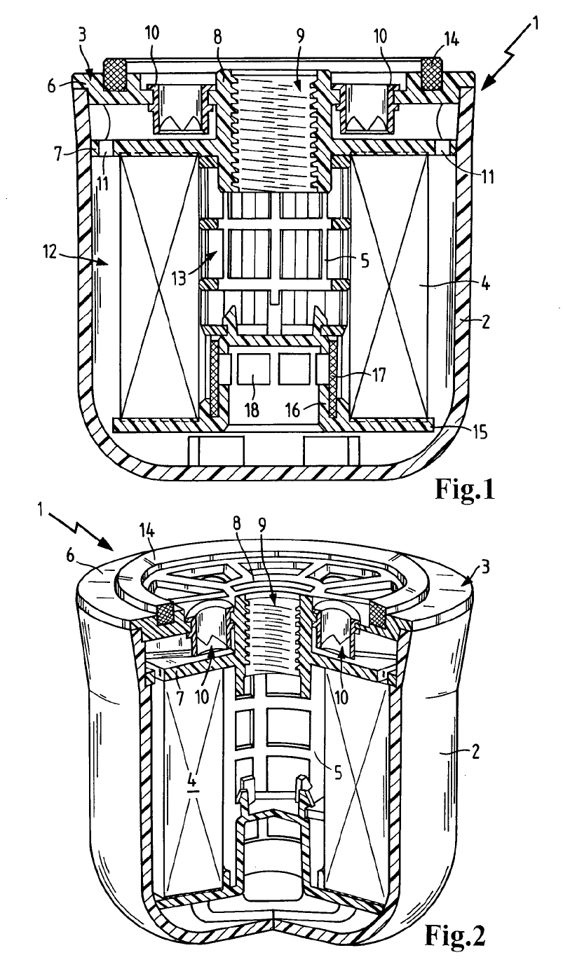

The filtering system 1 illustrated in FIGS. 1 and 2 is used in particular in internal combustion engines for filtering liquids such as oil or fuel. The filtering system 1 comprises a filter housing 2 made from plastic material which is approximately cup-shaped and can be closed by a lid 3. Into the receiving space in the filter housing 2 a filter element 4 is inserted that is of a cylindrical hollow configuration and is supported by a support member 5 made from plastic material and arranged in the interior of the filter element 4. Liquid passes the filter element 4 from the exterior to the interior in the radial direction so that the exterior side of the filter element 4 is the raw side 12 and the interior of the filter element is the clean side 13.

The lid 3 is made completely from plastic material and comprises two individual disks 6 and 7 that are parallel to one another and have approximately the same radius and are connected to one another by a central cylindrical hollow flow socket 8. The two individual disks 6 and 7 as well as the flow socket 8 form together a monolithic plastic component that, for example, can be produced by injection molding or by another method such as, for example, deep drawing. Optionally, in the space between the two parallel individual disks 6 and 7 additional connecting webs are provided by means of which the two individual disks support one another and which significantly increase the stability of the lid 3.

The central socket 8 that connects as a component of the lid 3 the two individual disks 6 and 7 has an inner connecting thread 9 by means of which the lid 3 and thus also the entire filtering system 1 can be connected to a component of the internal combustion engine. At the same time, the flow socket 8 acts as an outlet opening communicating with the clean side 13 of the filter element 4 and through which the filtered liquid can be removed axially from the filtering system 1. The flow socket 8 projects axially past the bottom side of the lower disk 7 facing directly the filtering element 4 and projects with a portion thereof into the cylindrical interior—the clean side 13—of the filter element 4.

The lower individual disk 7 is expediently directly connected to the end face of the filter element 4; this can be realized, for example, by means of welding or gluing to the end face of the filtering element. In this way, the lower individual disk 7 forms the end portion of the filter element and ensures, on the one hand, stability of the filter element and, on the other hand, separates clean side and raw side.

In the upper individual disk 6 facing away from the filter element 4 intake openings are provided into which check valves 10 are inserted. These check valves 10 are configured, for example, as beak valves that are shown in detail in FIGS. 8 and 9. The liquid to be filtered is introduced through the check valve 10 first into the space between the two individual disks 6 and 7 wherein the check valves 10 prevent liquid from spilling out when the filter element is removed upside down or the filtering system from draining completely when the motor is turned off. From the space between the individual disks 6 and 7 liquid flows through passages 11 in the lower individual disk 7 facing directly the filter element 4 to the raw side 12 that is an annular gap between the inner wall of the filter housing 2 and the exterior side of the filter element 4. After having passed through the filter element 4 in the radial direction from the exterior to the interior, the filtered liquid is collected in the central cylindrical interior (clean side 13) and removed through the flow socket 8 of the lid 3.

On the top side of the upper individual disk 6 of the lid 3 a sealing ring 14 is inserted into a receiving groove provided for this purpose in the individual disk 6. The sealing ring 14 ensures a seal-tight connection of the filtering system 1 to a component of the internal combustion engine to which the filtering system is to be connected.

In the lower area of the filtering system 1 facing the bottom of the filter housing 2, the filter element 4 is sealed by an end plate 15 at the end face. This end plate 15 that is located on the end face of the filter element opposite the lid 3 has a projecting cup-shaped fastening socket 16 that projects from below into the clean chamber 13 of the filter element 4. The exterior side of the fastening socket 16 projecting past the plane of the end plate 15 is surrounded by a sealing hose 17 that has the function of an overflow valve. In the axially extending walls of the fastening socket 16 cutouts 18 are provided that are covered by the sealing hose 17 and in general the cutouts 18 are closed in a seal-tight way. However, should the pressure at the raw side 12 surpass a limit value, in particular, be higher than the pressure at the dean side 13, the filtered liquid flows through the bottom of the filter housing 2 from below into the cutouts in the fastening socket 16 and loads by means of the cutouts 18 the inner side of the sealing hose 17 so that the sealing hose is radially widened and the unfiltered liquid can pass directly through the cutouts 18 from the raw side 12 to the dean side 13. As the pressure decreases, the cutouts 18 are then again closed off seal-tightly by the elastic tension of the sealing hose 17. The sealing hose 17 combines in one component the functions of a valve body and of a valve spring that loads the valve body into the closed position.

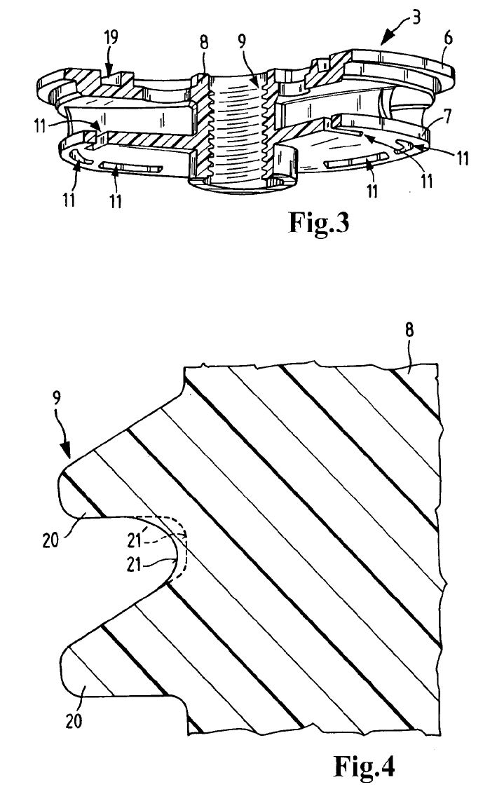

In FIG. 3, the lid 3 is shown alone. It can be seen that the passages 11 in the lower individual disk 7 are configured as slotted holes that extend in the circumferential direction of the lid. The passages 11 are located in the radial outer area of individual disk 7 and communicate in the mounted state of the lid directly with the raw side 12 of the filter element.

On the top side of the upper individual disk 6 there is a receiving groove 19 configured as a unitary part of the lid for receiving the sealing ring to be inserted.

FIG. 4 shows a section at an enlarged scale of the inner connecting thread 9 in the flow socket 8. The cross-sectional geometry between two neighboring teeth 20 of the thread is elliptical and follows the course indicated by the solid line 21. In comparison a conventional sawtooth geometry known from the prior art is indicated by dashed line 21′. The advantage of the elliptical geometry according to the solid line 21 resides in the reduced tension, and this enables the use of a comparatively soft material such as plastic material.

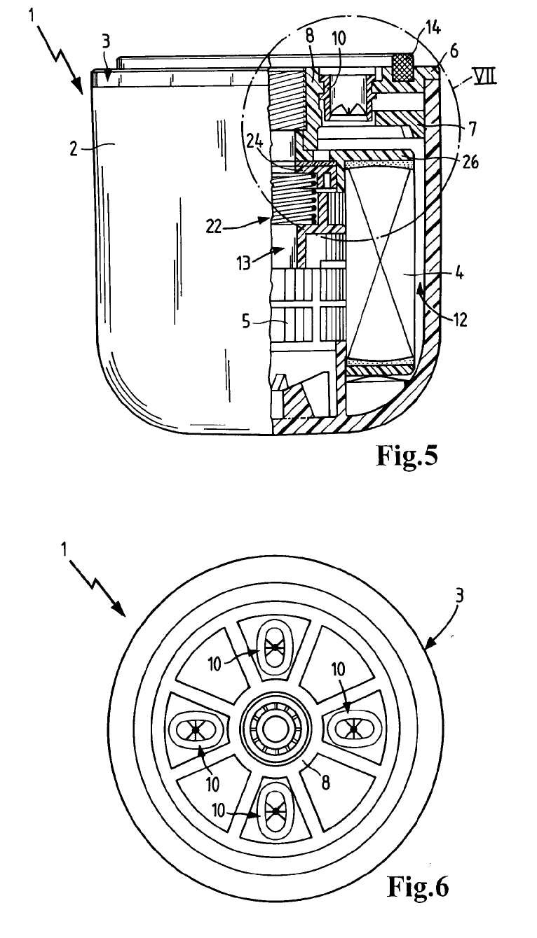

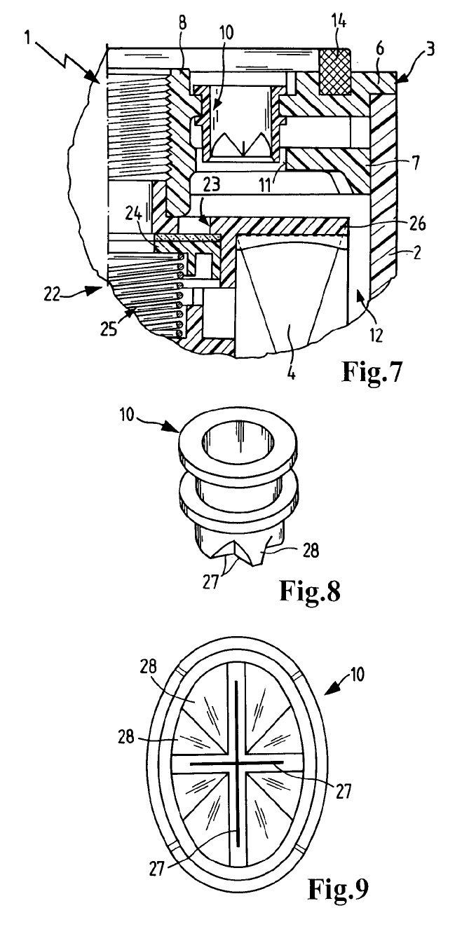

FIGS. 5 through 7 shows a further embodiment for a filtering system 1 for filtering liquids. The filtering system has an overflow valve 22 at the upper area of the filter element 4 facing the lid 3 that under regular conditions closes off an overflow opening 23 between the raw side 12 and the dean side 13 of the filter element. This overflow opening 23 is provided in an end face plate 26 that is fixedly connected to the upper end face of the filter element 4. The end face plate 26 is embodied as a separate component independent of the lid 3 but is connected to the lid. In the context of the present invention it can also be expedient to connect the lower individual disk 7 of the lid 3 directly with the end face of the filter element 4 wherein, in this case, the overflow opening 23 is provided in the individual disk 7. Moreover, there is also the possibility of embodying the end face plate 26 and the lid 3 as a monolithic plastic component.

The overflow valve 22 comprises a closure disk 24 that has the function of the valve body and is arranged on the clean side 13 of the filter element so as be axially slidable; it is loaded by a valve spring 25 into the closed position in which the closure disk 24 rests seal-tightly against the overflow opening 23 in the end face plate 26. The valve spring 25 is supported on the support member 5 of the filter element 4.

The liquid to be filtered is introduced through the check valve 10 into the interior of the filtering system; there are a total of four check valves 10 arranged in the lid 3: When the pressure of the supplied liquid surpasses a certain limit value, the closure disk 24 is moved against the force of the valve spring 25 from its closed position axially downwardly so that a flow path through the overflow opening 23 is released that directly connects the raw side 12 and the clean side 13. After the pressure has dropped, the force of the valve spring 25 is sufficient in order to move the closure disk 24 against the applied pressure on the raw side 12 upwardly into the closed position in which the overflow opening 23 is again seal-tightly closed. Expediently, all components of the overflow valve 22 are comprised of plastic material, i.e., particularly the closure disk 24 as well as the valve spring 25.

FIGS. 8 and 9 show an embodiment for a check valve 10 that is embodied as a beak valve and is inserted into openings in the lid 3 and through which liquid to be filtered is supplied to the filtering system 1. The beak valve 10 is also completely made of plastic material. At the outlet side, the beak valve 10 has two slots 27 in a crossed arrangement that, under normal conditions, are open so that the liquid to be filtered can pass through the valve 10. As a result of the elastic properties of the plastic material of the valve 10, the wall sections 28 of the check valve that delimit the flow slots 27 can be pressed together when a pressure is present that acts on the wall sections 28 and surpasses a limit value so that the flow slots 27 are closed and passage of liquid through the check valve 10 is impossible. As the external pressure decreases, the flows slots 27 again open as a result of the elastic tension of the material of the check valve 10 so that passage through the check valve is made possible again.

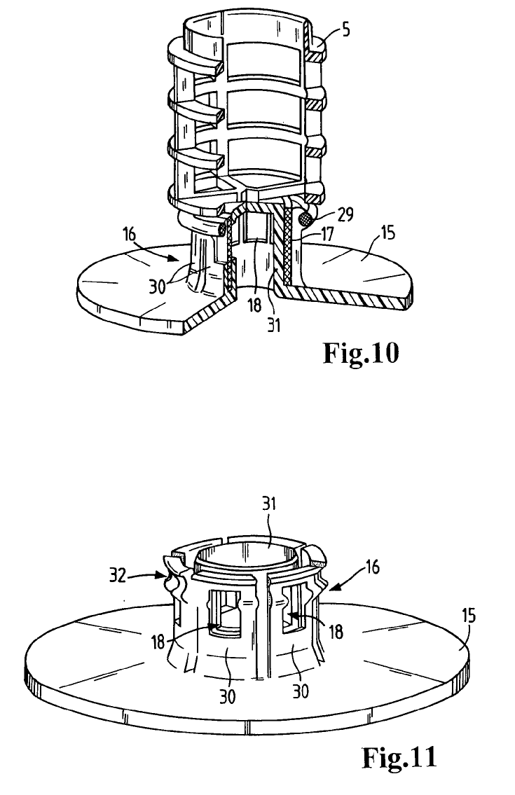

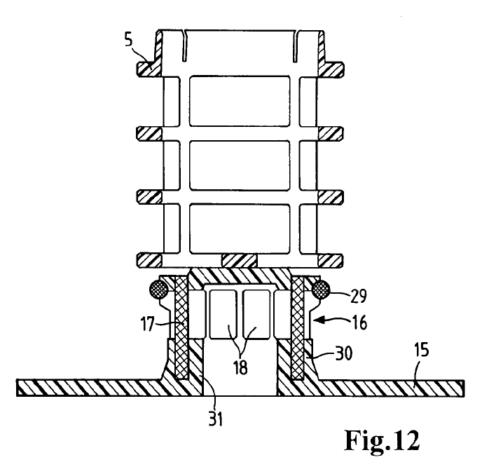

FIGS. 10 to 12 show an embodiment of an overflow valve between raw side and the clean side that is arranged in the lower area of the filter element near the bottom. A central fasting socket 16 projects from the end plate 15 that is arranged close to the bottom in the receiving space of the filter housing 2; a cylindrical sealing hose 17 is placed about the socket as a valve body. The central fasting socket 16 comprises separate, vertically projecting wall section 30 that are placed in a circle about a central projection 31. The individual wall sections 30 and the end plate 15 comprised of plastic material are embodied together as a unitary part and the wall sections can be elastically springy. This makes it possible to insert a sealing ring 29 into a circumferential groove 32 that is provided on the exterior side of the wall sections 30.

The sealing hose 17 that forms the valve body is inserted into the space between the central cup-shaped projection 31 and the wall sections 30 surrounding the projection. The sealing hose closes off in this way the cutouts 18 that are provided in the walls of the central projection 31.

The unfiltered liquid on the raw side of the filter element passes from below axially into the interior of the central projection 31 and loads the sealing hose 17 from the interior with pressure in the radial outward direction. Upon surpassing a pressure limit at the raw side, the sealing hose 17 widens to such an extent that a flow connection through the cutouts 18 between raw side and dean side is generated so that the liquid to be filtered can pass directly to the dean side. As the pressure decreases on the raw side, the overflow valve closes again automatically by contraction of the sealing hose.

All components of the overflow valve (with the exception of the sealing hose) are comprised of plastic material; this significantly improves the recyclability.

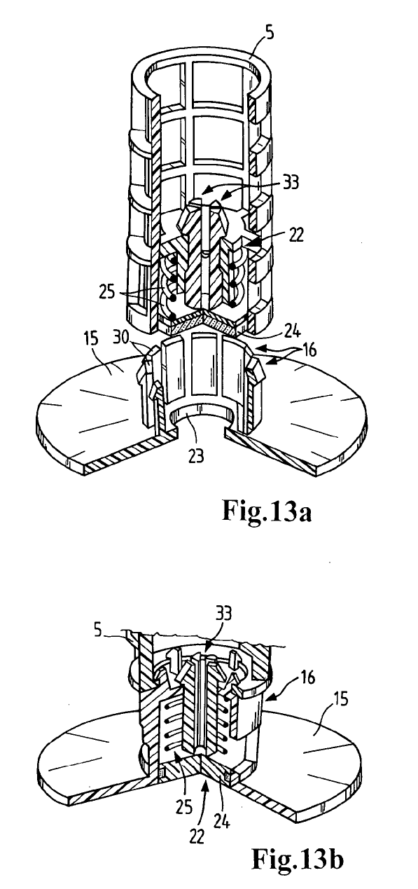

FIG. 13a shows a further embodiment of an overflow valve 22 provided in the bottom area of the filter element. In this embodiment, all components are comprised of plastic material. The valve body of the overflow valve 22 is formed by a closure disk 24 that has monolithic snap-on hooks 33 that captively lock in place in the interior of the support member 5 at a locking opening of the support member but are secured so as to be axially slidable. In this way, the closure disk 24 can be moved axially between a closed position in which an overflow opening 23 in the bottom end plate 15 is seal-tightly closed and an open position. The closure disk 24 is loaded by a valve spring 25 into its closed position. Under regular conditions the overflow opening 23 that is surrounded by the individual wall sections 30 of the fasting socket 16 is closed seal-tightly by the closure disk 24, Should the pressure on the raw side surpass a limit value, the unfiltered liquid passes from below through the overflow opening 23 and contacts the closure disk 24 and loads the latter with an opening pressure counter to the force of the valve spring 25 so that the closure disk 24 is lifted and a flow connection between the raw side and the clean side is provided. With decreasing pressure, the closure disk 24 can return under the effect of the valve spring 25 into the closed position in which the overflow opening 23 is closed.

The overflow valve 22 illustrated in FIG. 13b corresponds in its basic construction to that of FIG. 13a but with the difference that the valve spring 25 as well as the snap-on hooks 33 on the valve body are supported directly on the fasting socket 16 and not on the support member 5 of the filter element. The support member 5 is seated on the fasting socket 16 which is expediently formed as a unitary part of the end plate 15 but optionally can be also a component that is separate from the end plate 15.

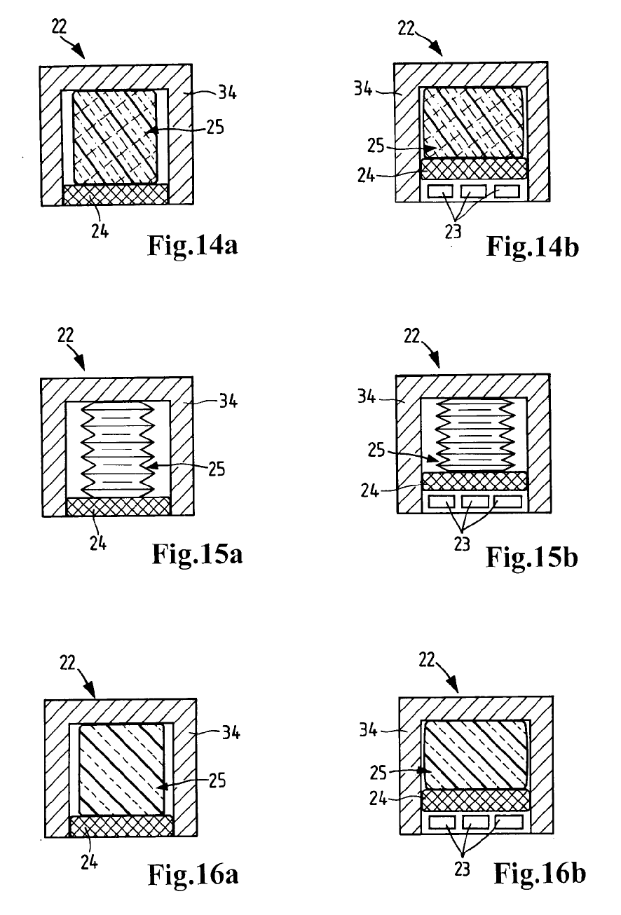

In FIGS. 14a to 16b different embodiments of constructively simple overflow valves 22 are shown that in the closed position separate the raw side from the clean side of the filter element and in the open position enable a direct passage of the unfiltered liquid. In a valve housing 34 the valve body that is embodied as a closure disk 24 is arranged to be axially slidable and is secured by a valve spring 25 in the closed position. When a force acts on the closure disk 24 from the exterior against the spring force of the valve spring 25, the closure disk 24 is moved in the direction of the interior of the valve housing 34 so that the overflow openings 23 in the wall of the valve housing 34 are released and a direct flow connection between the raw side and the clean side of the filter element is provided. In the three illustrated embodiments, the valve spring 25 is embodied as an elastic springy block wherein in the embodiment of FIGS. 14a and 14b the valve spring 25 is an elastomer block, in the FIGS. 15a and 15b it is an elastomer bellows, and in the embodiment according to FIGS. 16a and 16b it is a foam spring block comprised of PUR foam or silicone foam.

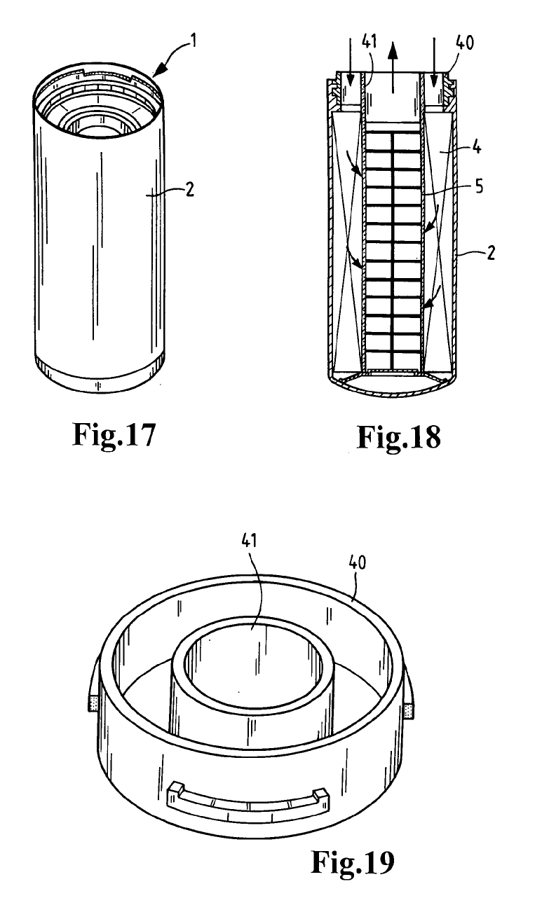

In FIGS. 17 to 21 a further embodiment of a filtering system for filtering liquids is illustrated. The filtering system 1 has a cylindrical filter housing 2 in which an annular filter element 4 is received and the liquid to be filtered passes through it radially. For this purpose, the liquid to be filtered, as illustrated in FIG. 18, is introduced at the end face into the filter housing 2. For filtering, the liquid flows through the filter element 4 radially from the exterior to the interior and is subsequently removed axially from the filter housing from the interior that represents the clean side. For supporting the filter element 4 a support structure 5 is provided. On the axial end face through which the liquid is introduced or removed, there are concentrically arranged connecting rings 40 and 41 that separate the clean chamber from the raw side. The space between the connecting rings 40 and 41 characterizes the raw side, the interior within the smaller connecting ring 41 is the clean side.

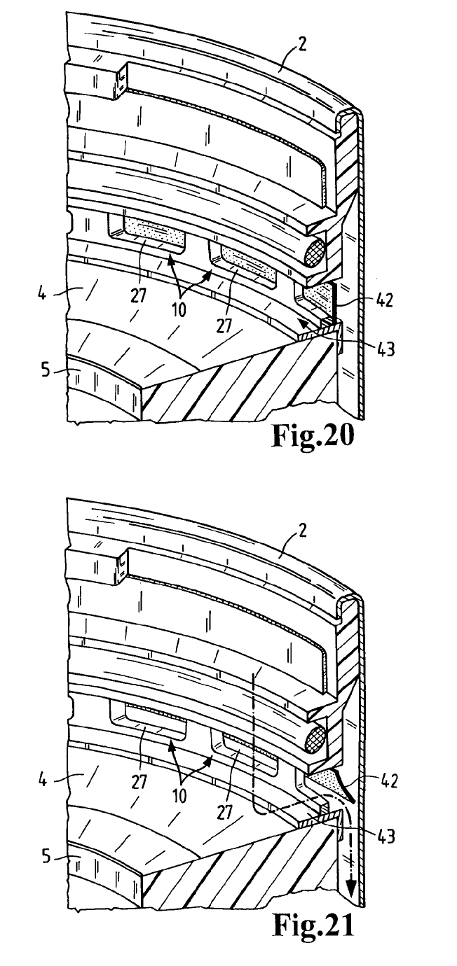

As can be taken from the detailed illustrations of FIGS. 20 and 21, on the axial end face where the liquid is supplied or removed a radially outwardly positioned support ring 43 is provided on the filter element 4 in which radial flow outlet openings 27 are provided that are distributed uniformly about the circumference of the support ring. On the radial outer side the flow openings 27 are covered by a sealing hose 42 that is comprised of flexible elastic material and rests under its own elastic tension on the radial outer side of the support ring 43 for covering the flow openings 27. The support ring 43 forms together with the sealing hose 42 a check valve 10 embodied as a hose valve that, when an appropriate pressure differential between radial inner side and radial outer side acts on the sealing hose 42, is transferred into the open position illustrated in FIG. 21 in which at least portions of the sealing hose 42 are lifted off the blocking position in which it rests against the flow outlet openings 27 so that a radial flow through the flow outlet openings 27 can be realized. The pressure on the inner side generated by the supplied liquid to be filtered lifts the sealing hose 42 radially out of the sealing position so that the flow outlet openings 27 are released. As soon as the pressure differential between the inner side and the outer side on the seating hose drops below a limit value that is determined primarily by the elasticity of the sealing hose, the seating hose assumes again its sealing position closing off the flow outlet openings.

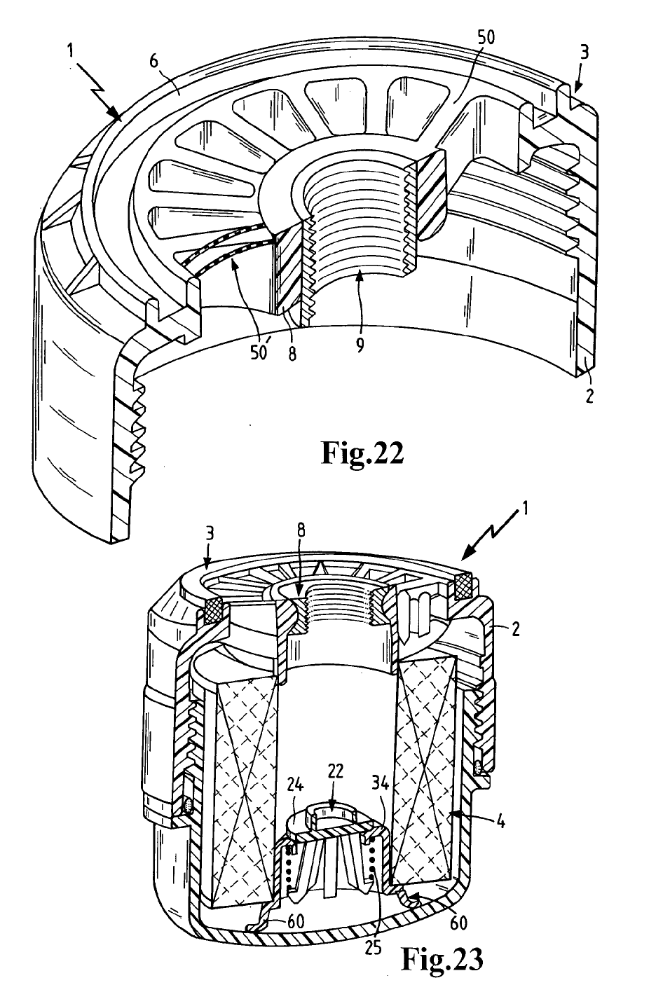

In FIG. 22 a further embodiment of a filtering system 1 for liquid filtration is illustrated. The cup-shaped filter housing 2 in which the filter element is received is closed off by an exterior lid 6 at the end face; it comprises an integral central flow socket 8 with inner thread 9. Between the flow socket 8 and a radially outwardly positioned rim of the individual disk 6 radially extending spokes 50 are provided. Several such spokes are provided and are arranged at a regular spacing about the circumference of the individual disk 6. The spokes 50 have a straight configuration and extend expediently exclusively in the radial direction. As indicated with dashed lines, it can also be expedient to provide curved spokes 50′ that, in addition to the radial component, also have a component in the circumferential direction. Moreover, straight spokes are also conceivable that extend at an angle relative to the radial direction.

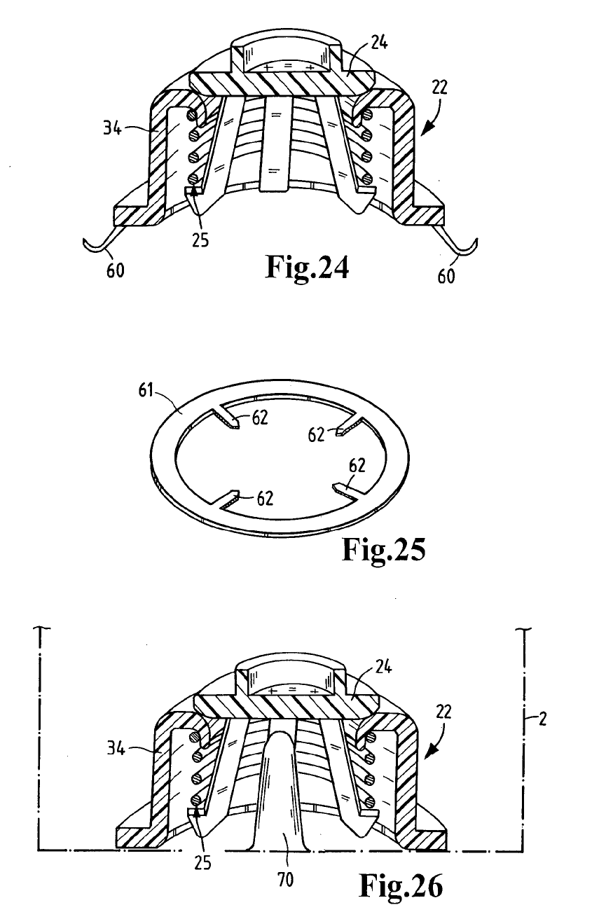

In FIGS. 23 to 25, a further embodiment for a filter device for liquid filtration is illustrated. The filter element 4 is of an annular configuration wherein the inner side represents the clean side and the radial outer side is the raw side of the filter element. In the area of an axial end face of the filter element 4 there is an overflow or bypass valve 22 that is expediently manufactured completely of plastic material and has a valve housing 34 that is insertable into the axial interior of the filter element 4 in the area of an end face. In the valve housing 34 there is a valve spring 25 configured as a coil spring that, in particular, exerts a pressure force. This valve spring 25 loads a closure disk 24 functioning as a valve body into the closed position. When the liquid pressure surpasses a limit value on the raw side, the closure disk 24 is opened against the force of the valve spring 25 so that a direct flow passage between the raw side and the clean side is provided.

In the area of the axial end face on the valve housing 34 several support legs 60 are arranged that project past the axial end face of the filter element 4 and are formed expediently on the valve housing 34 as a unitary part thereof. These support legs 60 have the function of an elastic springy support means so that when inserting the filter element 4 into the filter housing 2 an axial tolerance compensation upon placement onto the bottom of the filter housing is achieved. Moreover, by means of the support legs 60 the filter element is centered and guided within the housing. Moreover, it is ensured that the filter element cannot be mounted accidentally in the wrong orientation.

Expediently, three or four such support legs 60 are provided on the end face of the valve housing 34 in uniform distribution about the circumference. As shown in FIG. 25, it can also be expedient to provide instead of the support legs a support ring 61 on the axial end face of the valve housing 34 wherein the support ring 61 has support elements 62 that are embodied as radially inwardly extending pin-like support springs that extend in an axial direction relative to the plane of the support ring 61.

In FIG. 26 a further embodiment is illustrated in which a bypass valve 22 cooperates with a spike 70 on the bottom of the cup-shaped filter housing 2. The bypass valve 22 between the raw side and the clean side of the filter element to be inserted into the filter housing has a closure disk 24 that forms the valve body and is force-loaded by the valve spring 25 into its sealing position on the valve housing 34. The valve housing 34 is approximately cup-shaped wherein the open cup side faces the bottom of the filter housing. The closure disk 24 is positioned at a spacing relative to the bottom of the filter housing and the lateral walls of the valve housing as well as the closure disk 24 delimit a receiving space into which the pin or spike 70 projects; the pin or spike is attached to the bottom of the filter housing.

This pin 70 has the task of moving the valve body of the bypass valve into the open position in case that a wrong filter element including bypass valve is inserted into the filter housing so that, despite the filter element not being the right one, a direct flow connection between raw and clean sides is provided and in this way a passage for the liquid through the filtering system is ensured. In particular when used as a fuel filter an emergency supply of the internal combustion engine with fuel is ensured in this way, even though accidentally the wrong filter has been inserted.

When the filter element and bypass valve are used correctly, the pin has instead only a centering function for centering the filter element in the filter cup but not an opening function for the bypass valve. In this case, the pin projects into the recess in the valve housing 34 without however loading and moving the closure disk 24 into the open position. When the filter element is correctly inserted or when the correct filter element is inserted, the closure disk 24 is positioned even in its closing position with sufficient spacing relative to the tip of the pin.

A further advantage of such a pin resides in that, when using the proper filter element for the filtering system, an accidental insertion of this filter element in the wrong position is prevented. Should the filter element be inserted accidentally in the wrong orientation into the filter cup, the end plate at the end face of the filter element contacts the pin 70 so that the filter element cannot be completely inserted into the filter cup; this is immediately noticed during mounting.

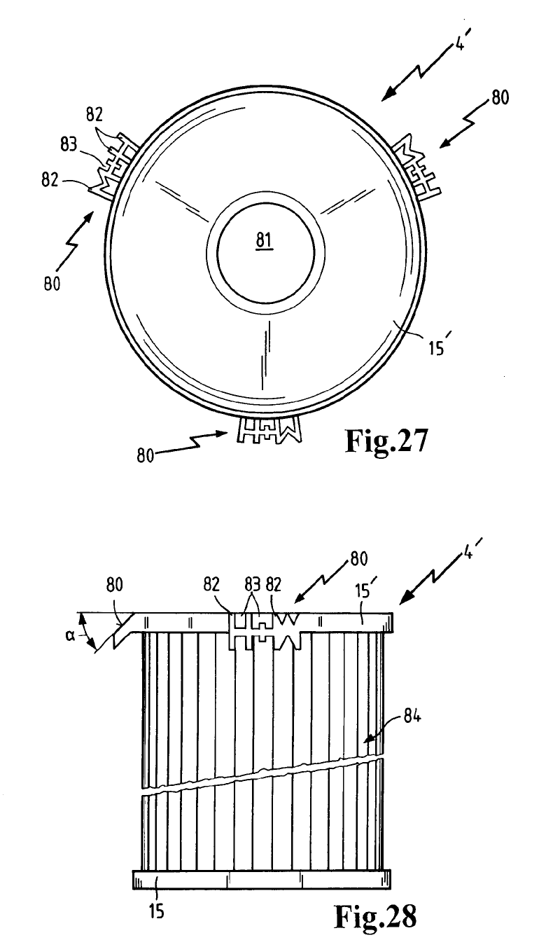

In FIG. 27 a filter element 4′ is shown in plan view. The filter element 4′ has an upper end plate 15′ made from thermoplastic material. The end plate 15′ is essentially embodied as an annular disk. A central opening 81 is provided through which the fluid can flow. In other embodiments the end plate 15′ can also be simply a circular disk. The opening 81 for the fluid is then arranged on the opposite side. In addition to the circular shape or annular ring shape the end plate 15′ can, of course, also have any other suitable geometric shape, for example, can be square, rectangular, or polygonal, in particular, hexagonal. The end plate 15′ has at its circumference three key structures 80 distributed about the periphery. The number and distribution of the key structures 80 on the periphery is arbitrary. Accordingly, it is also possible to provide only a single or several such key structures 80 on the periphery. The key structure 80 projects with its geometric shape past the outer circumference of the end plate 15′ wherein the key structure 80 has material webs 82 or gaps 83 of different widths.

The key structure 80 in this embodiment is in the form of the letters M+H″. Of course, all letters can be combined in any sequence and number for forming the key structure 80. Advantageously, the letters are selected such that they represent a company logo or an abbreviation of a company name or product name. The key structure 80 can also be formed by other characters, for example, Japanese or Chinese characters, or Arabic or Roman numerals.

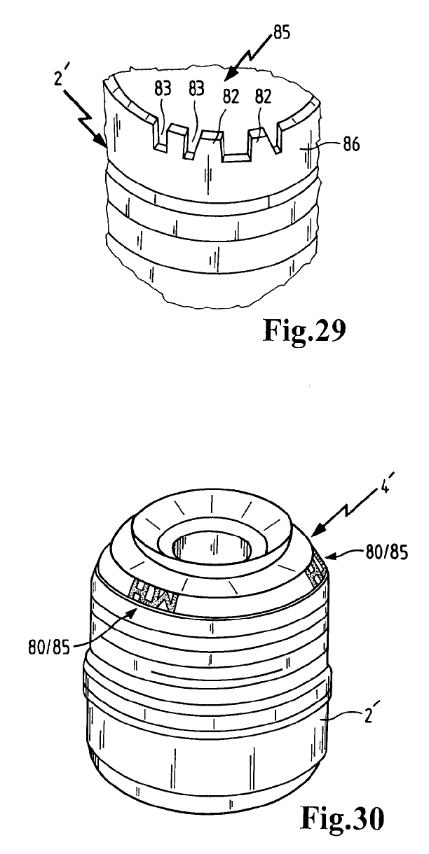

In FIG. 28, the filter element 4′ is shown in a side view. Components corresponding to those of FIG. 27 are provided with the same reference numerals. The filter element 4 has in addition to the upper end plate 15′ and the lower end plate 15 also a zigzag folded and annular filter medium 84. The filter medium 84 is connected seal-tightly to the end plates 15, 15′. In this embodiment the key structure 80 is slantedly arranged with its area projecting radially past the circular shape of the end plate 15′ relative to the surface of the end plate 15′. In this connection, the slant angle α of the key structure 80 is approximately 45° . The slant angle α however can have any suitable value between 0° and 90° , preferably between 30° and 60° . The key structure 80 engages a lock structure 85 illustrated in the perspective detail view of the filter housing 2′ in FIG. 29.

The lock structure 85 is arranged on the cup-shaped filter housing 2′ that is suitable for receiving the filter element 4′. In this connection, the lock structure 85 has a negative geometry relative to the key structure 80 so that the material webs 82 of the key structure 80 engage gaps 83 of the lock structure 85. The material webs 82 of the lock structure 85 engage gaps 83 of the key structure 80. The lock structure 85 of the filter housing 2′ in this embodiment is configured as a notch in the filter housing wall 86. The notches can extend across the entire material thickness of the filter housing wall 86 or can be only a partial recess. In the case of a partial recess a portion of the filter housing wall 86 remains and is adjoined by the key structure 80. In other embodiments, the lock structure 85 can be arranged at an angle relative to the filter housing wall 86 and can engage notches in the end plate 15′. By the interaction of the key and lock structures 80, 85, structures 80, 85 supplement one another to a unit. The filter element 4′ can thus be inserted only in the proper mounting position into the filter housing. The insertion of impermissible filter elements is therefore recognized immediately and prevented when the filter element 4′ is not properly mounted. An arrangement of the key structure 80 on the filter housing 2′ is of course possible when the corresponding lock structure 85 is provided on the filter element 4′.

In FIG. 30, a filter element 4′ according to FIG. 28 is illustrated in the mounted state in a filter housing 2′ according to FIG. 29. The structures 80, 85 of the filter element 4′ and of the filter housing 2′ supplement one another in such a way that the filter element 4′ is positioned exactly in the filter housing 2′ and relative rotation is prevented. This preassembled unit of filter element 4′ and filter housing 2′ can subsequently be screwed into the corresponding receptacle, for example, on a filter head (not illustrated) or a lid (not illustrated). The described lock and key structures 80, 85 can be combined in any way with the aforementioned described embodiments and can thus provide expedient configurations.

While specific embodiments of the invention have been shown and described in detail to illustrate the inventive principles, it will be understood that the invention may be embodied otherwise without departing from such principles.

What is claimed is:

1. A filtering system comprising:
a filter housing;
a filter element arranged in the filter housing and having a raw side and a dean side, wherein a liquid introduced into the filter housing flows through the filter element from the raw side to the clean side;
an overflow valve disposed between the raw side and the clean side of the filter element;
wherein the overflow valve is moved into an open position should a pressure of the liquid on the raw side of the filter element surpass a limit value;
wherein the overflow valve comprises an adjustable valve body loaded by a valve spring;
wherein the valve body is made from plastic material;
wherein the filter element and the filter housing supplement one another structurally such that the filter element is positioned precisely in the filter housing and relative rotation of the filter element relative to the filter housing is prevented.

2. The filtering system according to claim 1, wherein the filter housing is cup-shaped and has a lock structure and the filter element has a matching key structure, wherein the lock structure has a negative geometry relative to the key structure and the negative geometry comprises gaps so that material webs of the key structure engage the gaps of the lock structure.

3. The filtering system according to claim 2, wherein the lock structure is a notch in a wall of the filter housing.

4. The filtering system according to claim 1, wherein the valve body is a monolithic component that can be snapped into the overflow valve.

5. The filtering system according to claim 1, wherein the filter element has a center tube, wherein the overflow valve is received in a support member and the support member is the center tube of the filter element.

6. The filtering system according to claim 1, wherein the overflow valve has support means that project past an end face of the filter element in an axial direction of the filter element.

7. The filtering system according to claim 6, wherein the support means are support legs.

8. The filtering system according to claim 6, wherein the support means is a support ring.

9. The filtering device according to claim 6, wherein the support means are elastically springy.

10. The filtering system according to claim 1, wherein the filter housing has a bottom provided with a pin and wherein the overflow valve has a valve housing provided with a recess into which recess the pin of the bottom of the filter housing projects.
